(19) United States
(12) Patent Application Publication
(10) Pub. No.: US 2008/0126622 A1
(43) Pub. Date: May 29, 2008

(54) Method and System for Optimizing CPU Performance for Network Ingress Flow

(76) Inventors: Eliezer Tamir, Beit Shemesh (IL); Shay Mizrachi, Hod HaSharon (IL)

Correspondence Address: MCANDREWS HELD & MALLOY, LTD, 500 WEST MADISON STREET, SUITE 3400, CHICAGO, IL, 60661, US

(21) Appl. No.: 11/945,463

(22) Filed: Nov. 27, 2007

Related U.S. Application Data
(60) Provisional application No. 60/867,490, filed on Nov. 28, 2006.

(51) Int. Cl. G06F 13/00

(52) U.S. Cl. 710/52; 711/137; 711/E12.057

(57) ABSTRACT

Certain exemplary aspects of a method and system for optimizing CPU performance for network ingress flow may include prefetching a plurality of socket buffers from host memory utilizing a virtual address database. The prefetched plurality of socket buffers may be cached. A plurality of data segments extracted from the cached plurality of socket buffers may be copied to a plurality of user buffers. The plurality of data segments may be received from a NIC. The NIC may be enabled to place header information corresponding to the received plurality of data segments in a FIFO memory buffer. The received plurality of data segments may be classified based on the placed header information in the FIFO memory buffer.

### CROSS-REFERENCE TO RELATED APPLICATIONS/INCORPORATION BY REFERENCE

This application makes reference to, claims priority to, and claims benefit of U.S. Provisional Application Ser. No. 60/867,490, filed on Nov. 28, 2006.

The above stated application is hereby incorporated herein by reference in its entirety.

### FIELD OF THE INVENTION

Certain embodiments of the invention relate to network interfaces. More specifically, certain embodiments of the invention relate to a method and system for optimizing central processing unit (CPU) performance for network ingress flow.

### BACKGROUND OF THE INVENTION

The TCP/IP protocol has long been the common language for network traffic. However, processing TCP/IP traffic may require significant server resources. Specialized software and integrated hardware known as TCP offload engine (TOE) technology may eliminate server-processing constraints. The TOE technology may comprise software extensions to existing TCP/IP stacks that may enable the use of hardware data planes implemented on specialized TOE network interface cards (TNIC). This hardware and/or software combination may allow operating systems to offload all TCP/IP traffic to the specialized hardware on the TNIC, leaving TCP/IP control decisions on the server. Most operating system vendors prefer this approach, which is based on a data-path offload architecture.

The NICs may process TCP/IP operations in software, which may create substantial system overhead, for example, overhead due to data copies, protocol processing and interrupt processing. The increase in the number of packet transactions generated per application network I/O may cause high interrupt load on servers and hardware interrupt lines may be activated to provide event notification. For example, a 64 K bit/sec application write to a network may result in 60 or more interrupt generating events between the system and a NIC to segment the data into Ethernet packets and process the incoming acknowledgements. This may create significant protocol processing overhead and high interrupt rates. Another significant overhead may include processing of a packet delivered by the TNIC. This processing may occur in the TNIC driver and a plurality of layers within the operating system. While some operating system features such as interrupt coalescing may reduce interrupts, the corresponding event processing for each server to NIC transaction, and processing of each packet but TNIC driver may not be eliminated.

A TNIC may dramatically reduce the network transaction load on the system by changing the system transaction model from one event per Ethernet packet to one event per application network I/O. For example, the 64 K bit/sec application write may become one data-path offload event, moving all packet processing to the TNIC and eliminating interrupt load from the host. A TNIC may be utilized, for example, when each application network I/O translates to multiple packets on the wire, which is a common traffic pattern.

Hardware and software may often be used to support asynchronous data transfers between two memory regions in data network connections, often on different systems. Each host system may serve as a source (initiator) system which initiates a message data transfer (message send operation) to a target system of a message passing operation (message receive operation). Examples of such a system may comprise host servers providing a variety of applications or services and I/O units providing storage oriented and network oriented I/O services. Requests for work, for example, data movement operations including message send/receive operations and remote direct memory access (RDMA) read/write operations may be posted to work queues associated with a given hardware adapter, the requested operation may then be performed. It may be the responsibility of the system which initiates such a request to check for its completion.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for optimizing CPU performance for network ingress flow, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary system for TCP offload, in accordance with an embodiment of the invention.

FIG. 1B is a block diagram of another exemplary system for TCP offload, in accordance with an embodiment of the invention.

FIG. 1C is an alternative embodiment of an exemplary system for TCP offload, in accordance with an embodiment of the invention.

FIG. 2 is a diagram illustrating an exemplary system for network ingress flow, in accordance with an embodiment of the invention.

FIG. 3A is a block diagram of an exemplary socket buffer, in accordance with an embodiment of the invention.

FIG. 3B is a block diagram of an exemplary system illustrating cache misses in network ingress flow, in accordance with an embodiment of the invention.

FIG. 4A is a block diagram of an exemplary virtual address database, in accordance with an embodiment of the invention.

FIG. 4B is a block diagram of an exemplary system illustrating optimization of CPU performance for network ingress flow, in accordance with an embodiment of the invention.

FIG. 5 is a flowchart illustrating exemplary steps for optimizing CPU performance for network ingress flow, in accordance with an embodiment of the invention.

### DETAILED DESCRIPTION OF THE INVENTION

Certain embodiments of the invention may be found in a method and system for optimizing CPU performance for network ingress flow. Aspects of the method and system may comprise prefetching a plurality of socket buffers from host memory utilizing a virtual address database. The prefetched plurality of socket buffers may be cached. A plurality of data segments extracted from the cached plurality of socket buffers may be copied to a plurality of user buffers. The plurality of data segments may be received from a NIC. The NIC may be enabled to place header information corresponding to the received plurality of data segments in a FIFO memory buffer. The received plurality of data segments may be classified based on the placed header information in the FIFO memory buffer.

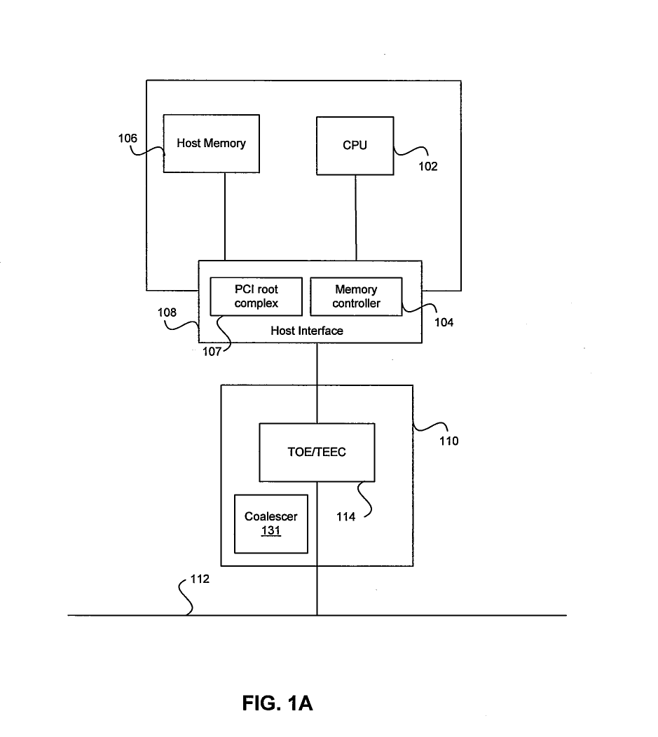

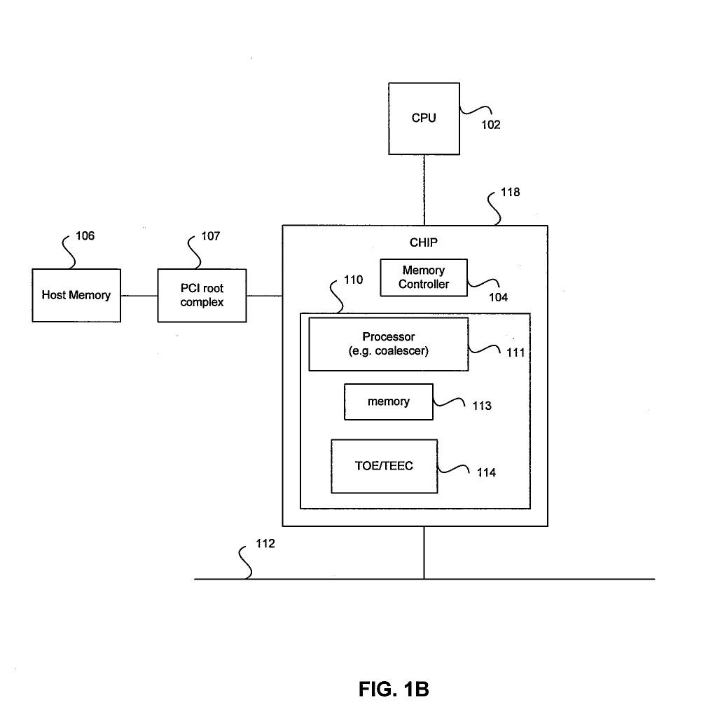

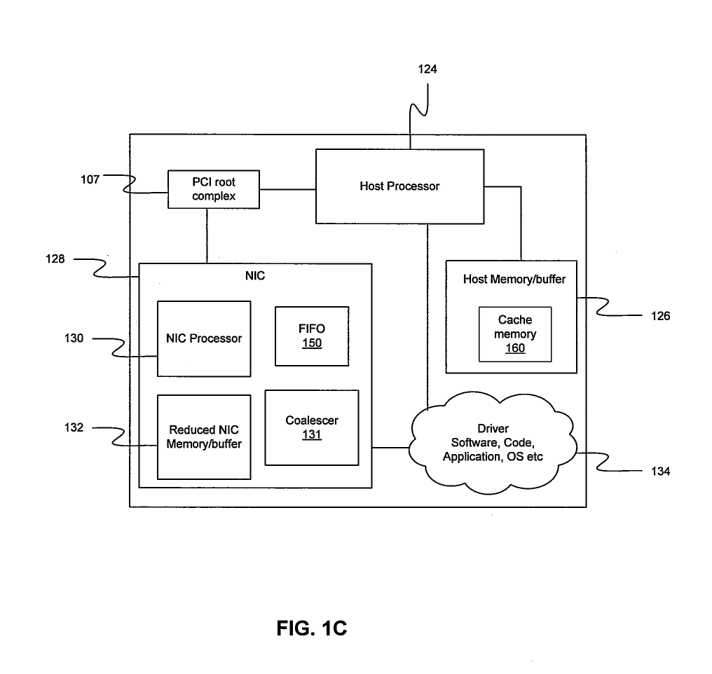

FIG. 1A is a block diagram of an exemplary system for TCP offload, in accordance with an embodiment of the invention. Accordingly, the system of FIG. 1A may be enabled to handle TCP offload of transmission control protocol (TCP) datagrams or packets. Referring to FIG. 1A, the system may comprise, for example, a CPU 102, a host memory 106, a host interface 108, network subsystem 110 and an Ethernet bus 112. The network subsystem 110 may comprise, for example, a TCP-enabled Ethernet Controller (TEEC) or a TCP offload engine (TOE) 114 and a coalescer 131. The network subsystem 110 may comprise, for example, a network interface card (NIC). The host interface 108 may be, for example, a peripheral component interconnect (PCI), PCI-X, PCI-Express, ISA, SCSI or other type of bus. The host interface 108 may comprise a PCI root complex 107 and a memory controller 104. The host interface 108 may be coupled to PCI buses and/or devices, one or more processors, and memory, for example, host memory 106. Notwithstanding, the host memory 106 may be directly coupled to the network subsystem 110. In this case, the host interface 108 may implement the PCI root complex functionally and may be coupled to PCI buses and/or devices, one or more processors, and memory. The memory controller 106 may be coupled to the CPU 104, to the memory 106 and to the host interface 108. The host interface 108 may be coupled to the network subsystem 110 via the TEEC/TOE 114. The coalescer 131 may be enabled to aggregate a plurality of bytes of incoming TCP segments that have been placed to the host memory 106 but have not yet been delivered to a user application.

In accordance with an embodiment of the invention, the TEEC/TOE 114a may be utilized to classify the incoming packets based on the header information of the received packets. Notwithstanding, a classifier may be utilized instead of the TEEC/TOE 114a in order to classify the incoming packets.

FIG. 1B is a block diagram of another exemplary system for TCP offload, in accordance with an embodiment of the invention. Referring to FIG. 1B, the system may comprise, for example, a CPU 102, a host memory 106, a dedicated memory 116 and a chip 118. The chip 118 may comprise, for example, the network subsystem 110 and the memory controller 104. The chip set 118 may be coupled to the CPU 102 and to the host memory 106 via the PCI root complex 107. The PCI root complex 107 may enable the chip 118 to be coupled to PCI buses and/or devices, one or more processors, and memory, for example, host memory 106. Notwithstanding, the host memory 106 may be directly coupled to the chip 118. In this case, the host interface 108 may implement the PCI root complex functionally and may be coupled to PCI buses and/or devices, one or more processors, and memory. The network subsystem 110 of the chip 118 may be coupled to the Ethernet 112. The network subsystem 110 may comprise, for example, the TEEC/TOE 114 that may be coupled to the Ethernet bus 112. The network subsystem 110 may communicate to the Ethernet bus 112 via a wired and/or a wireless connection, for example. The wireless connection may be a wireless local area network (WLAN) connection as supported by the IEEE 802.11 standards, for example. The network subsystem 110 may also comprise, for example, an on-chip memory 113. The dedicated memory 116 may provide buffers for context and/or data.

The network subsystem 110 may comprise a processor such as a coalescer 111. The coalescer 111 may be enabled to aggregate a plurality of bytes of incoming TCP segments that have been placed to the host memory 106 but have not yet been delivered to a user application. Although illustrated, for example, as a CPU and an Ethernet, the present invention need not be so limited to such examples and may employ, for example, any type of processor and any type of data link layer or physical media, respectively. Accordingly, although illustrated as coupled to the Ethernet 112, the TEEC or the TOE 114 of FIG. 1A may be enabled for any type of data link layer or physical media. Furthermore, the present invention also contemplates different degrees of integration and separation between the components illustrated in FIGS. 1A-B. For example, the TEEC/TOE 114 may be a separate integrated chip from the chip set 118 embedded on a motherboard or may be embedded in a NIC. Similarly, the coalescer 111 may be a separate integrated chip from the chip set 118 embedded on a motherboard or may be embedded in a NIC. In addition, the dedicated memory 116 may be integrated with the chip set 118 or may be integrated with the network subsystem 110 of FIG. 1B.

FIG. 1C is an alternative embodiment of an exemplary system for TCP offload, in accordance with an embodiment of the invention. Referring to FIG. 1C, there is shown a host processor 124, a host memory/buffer 126, a software algorithm block or a driver 134 and a NIC block 128. The host memory/buffer 126 may comprise cache memory 160. The NIC block 128 may comprise a NIC processor 130, a processor such as a coalescer 131, a FIFO memory buffer 150 and a reduced NIC memory/buffer block 132. The NIC block 128 may communicate with an external network via a wired and/or a wireless connection, for example. The wireless connection may be a wireless local area network (WLAN) connection as supported by the IEEE 802.11 standards, for example.

The NIC 126 may be coupled to the host processor 124 via the PCI root complex 107. The NIC 126 may be coupled to PCI buses and/or devices, one or more processors, and memory, for example, host memory 106 via the PCI root complex 107. Notwithstanding, the host memory 106 may be directly coupled to the NIC 126. In this case, the host interface 108 may implement the PCI root complex functionally and may be coupled to PCI buses and/or devices, one or more processors, and memory. The coalescer 131 may be a dedicated processor or hardware state machine that may reside in the packet-receiving path. The host TCP stack may comprise software that enables management of the TCP protocol processing and may be part of an operating system, such as Microsoft Windows or Linux. The coalescer 131 may comprise suitable logic, circuitry and/or code that may be enabled to aggregate a plurality of bytes of incoming TCP segments that have been placed to the host memory 106 but have not yet been delivered to a user application. The CPU 102 may enable caching of the prefetched plurality of socket buffers in cache memory 160. The NIC 128 may be enabled to place header information corresponding to the received plurality of data segments in the FIFO memory buffer 150. The received plurality of data segments may be classified based on the placed header information in the FIFO memory buffer 150.

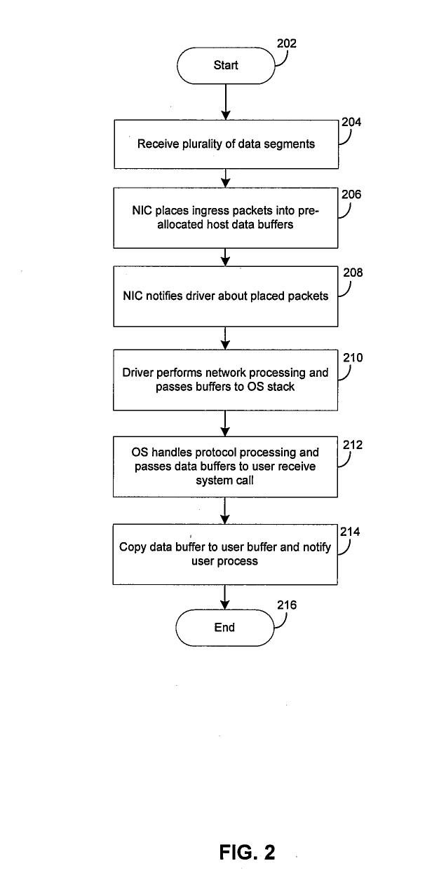

FIG. 2 is a diagram illustrating an exemplary system for network ingress flow, in accordance with an embodiment of the invention. Referring to FIG. 2, exemplary steps may begin at step 202. In step 204, the NIC 128 may receive a plurality of data segments. In step 206, the NIC 128 may place one or more received ingress data segments into pre-allocated host data buffers. The NIC 128 may be enabled to write the received data segments into one or more buffers in the host memory 126 via a peripheral component interconnect express (PCIe) interface, for example. In instances when an application receive buffer is available, the NIC 128 may be enabled to place the payload of the received data segment into a preposted buffer. In instances when an application receive buffer may not be available, the NIC 128 may be enabled to place the payload of the received data segment into a buffer selected from a global buffer pool that may be shared for all TCP connections on the same CPU/port. Notwithstanding, the invention may not be so limited. The received data segments maybe TCP/IP segments, iSCSI segments, RDMA segments or any other suitable network data segments, for example. The NIC 128 may be enabled to generate a completion queue element (CQE) to host memory 126 when a particular buffer in host memory 126 is full.

In step 208, the NIC 128 may notify the driver 134 about placed data segments. In step 210, the driver 134 may perform preliminary buffer management and network processing of the plurality of data segments. The driver may pass the host data buffers to the operating system (OS) stack. In step 212, the OS may perform protocol processing and pass the data buffers to a user receive system call. The user receive system call may comprise kernel code running on behalf of a user process in its context, for example. In step 214, the data buffers may be copied to user buffers and the user process may be notified. Control then passes to end step 216.

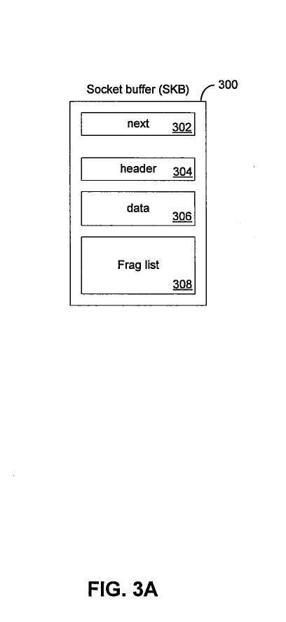

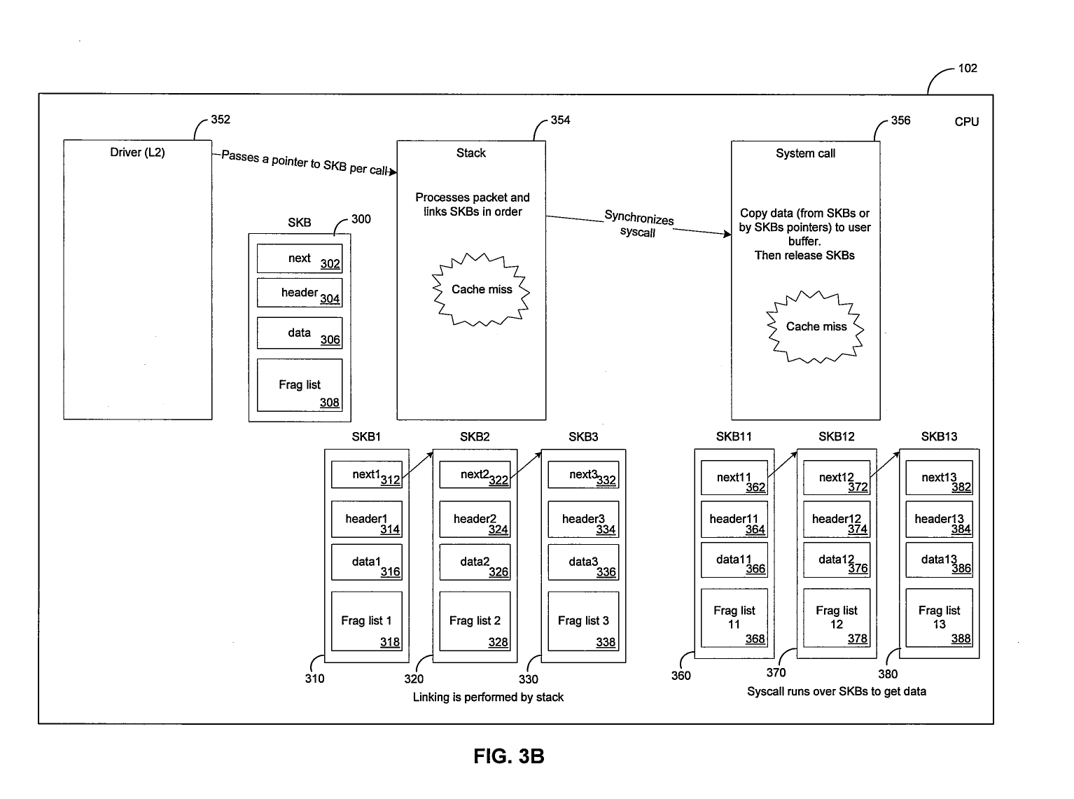

FIG. 3A is a block diagram of an exemplary socket buffer, in accordance with an embodiment of the invention. Referring to FIG. 3A, there is shown a socket buffer 300. The socket buffer (SKB) 300 may comprise a next field 302, a header field 304, a data field 306 and a frag list 308.

The next field 302 may point to the next SKB in a list. The header field 304 may comprise header information of a received data segment. The data field 306 may comprise payload of a received data segment. The frag list 308 may comprise a list of addresses of additional payload pages of received data segments.

FIG. 3B is a block diagram of an exemplary system illustrating cache misses in network ingress flow, in accordance with an embodiment of the invention. Referring to FIG. 3B, there is shown a CPU 102. The CPU 102 may comprise a driver 352, an OS stack 354 and a system call 356.

The driver 352 may be enabled to classify the received ingress data packets or segments from NIC 128 according to packet header information. The classification may involve at least one CPU 102 stall on each packet as packets may be stored in memory regions which are not contiguous. The buffers may be passed from the driver 352 to the OS stack 354 or from the OS stack 354 to the system call 356 as linked lists, for example. The driver 352 may be enabled to perform preliminary buffer management and network processing of the plurality of data segments. The driver 352 may be enabled to pass a pointer to SKB 300 per call, for example, to the OS stack 354.

The OS stack 354 may be enabled to perform protocol processing and link the plurality of SKBs, for example, SKB1 310, SKB2 320 and SKB3 330 in order. The SKB1 310 may comprise a next1 field 312, a header1 field 314, a data1 field 316 and a frag list 1 318. The SKB2 320 may comprise a next2 field 322, a header2 field 324, a data2 field 326 and a frag list 2 328. The SKB3 330 may comprise a next3 field 332, a header3 field 334, a data3 field 336 and a frag list 3 338. For example, the next field 312 in SKB1 310 may point to SKB2 320. The next field 322 in SKB2 320 may point to SKB3 330. The OS stack 354 may be enabled to pass the data buffers to a user receive system call 356 by synchronizing a system call (syscall) function. The CPU 102 may stall because of cache misses during OS stack 354 processing when the CPU 102 attempts to access incoming data segments and/or packets. A cache miss may occur when the CPU 102 attempts to access an address that was not recently used, for example. The CPU 102 cache controller may attempt to read ahead of previously accessed areas expecting them to be used. A successful read ahead may comprise stalling the CPU 102 once at the beginning while reading a contiguous region.

The system call 356 may comprise kernel code running on behalf of a user process in its context, for example. The system call 356 may enable copying of data to user buffers from the plurality of SKBs, for example, SKB11 360, SKB12 370 and SKB13 380 or a plurality of pointers to the plurality of SKBs, for example, SKB11 360, SKB12 370 and SKB13 380.

The SKB11 360 may comprise a next11 field 362, a header11 field 364, a data11 field 366 and a frag list 11 368. The SKB12 370 may comprise a next12 field 372, a header12 field 374, a data12 field 376 and a frag list 12 378. The SKB13 380 may comprise a next13 field 382, a header13 field 384, a data13 field 386 and a frag list 13 388. For example, the next field 362 in SKB11 360 may point to SKB12 370. The next field 372 in SKB12 370 may point to SKB13 380.

The system call 356 may be enabled to process the plurality of SKBs, for example, SKB11 360, SKB12 370 and SKB13 380 to extract data and release the plurality of SKBs, for example, SKB11 360, SKB12 370 and SKB13 380 after copying. The CPU 102 may stall because of cache misses during system call 356 processing when the CPU 102 attempts to access incoming data segments and/or packets.

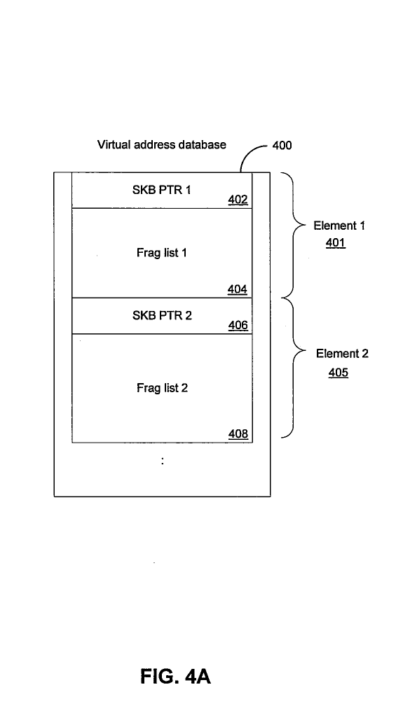

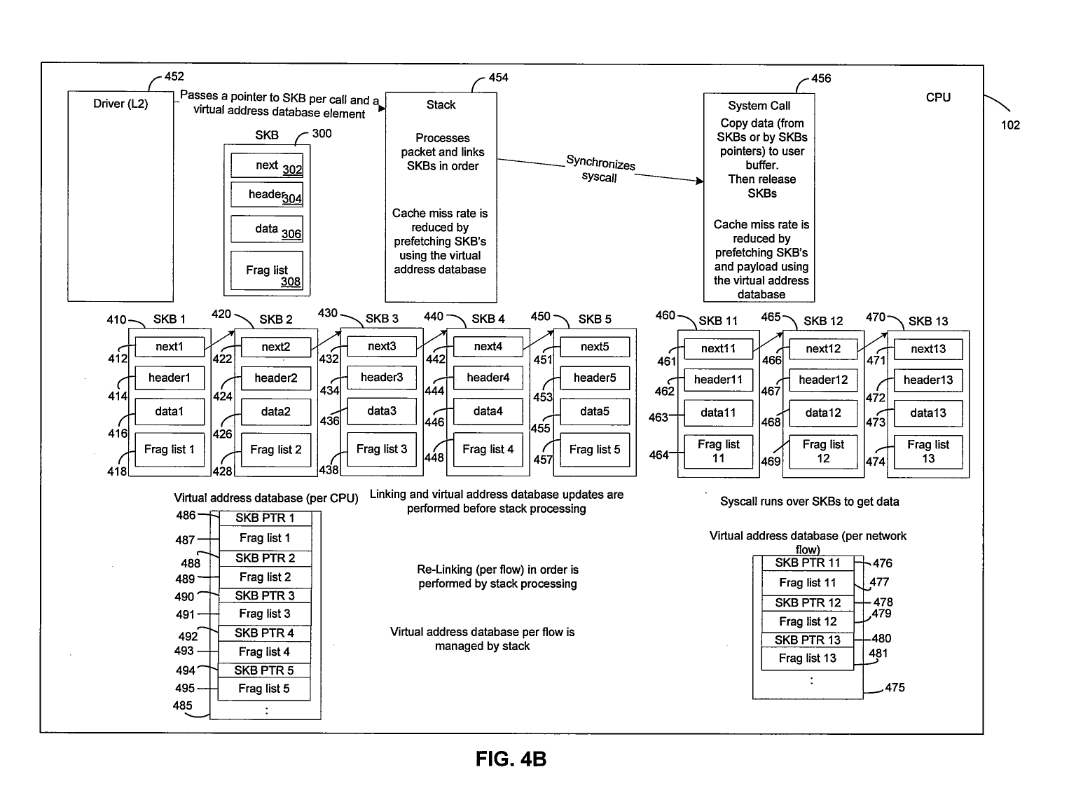

FIG. 4A is a block diagram of an exemplary virtual address database, in accordance with an embodiment of the invention. Referring to FIG. 4A, there is shown a virtual address database 400. The virtual address database (VAD) 400 may comprise a plurality of elements, for example, element 1 401, element 2 405 and so on. Each element may comprise a socket buffer pointer (SKB PTR) and a frag list. For example, element 1 401 may comprise SKB PTR 1 402 and frag list 1 404. Similarly, element 2 405 may comprise SKB PTR 2 406 and frag list 2 408.

The socket buffer pointer, for example, SKB PTR 1 402 may point to a particular socket buffer (SKB), for example, SKB1 312. The frag list, for example, frag list 1 404 may comprise a list of addresses of additional payload pages of received data segments in SKB1 312.

FIG. 4B is a block diagram of an exemplary system illustrating optimization of CPU performance for network ingress flow, in accordance with an embodiment of the invention. Referring to FIG. 4B, there is shown a CPU 102. The CPU 102 may comprise a driver 452, an OS stack 454 and a system call 456.

In accordance with an embodiment of the invention, a portion of packet classification may be performed by the NIC 128. The NIC 128 may be enabled to place header information corresponding to the received plurality of data segments in a FIFO memory buffer 150. The driver 452 may be enabled to classify the received plurality of data segments based on the placed header information in the FIFO memory buffer 150. The FIFO memory buffer 150 may comprise contiguous memory regions to store the placed header information. The driver 452 may not read the payload in order to classify an incoming packet. Therefore, processing may only stall once at the beginning when first reading from the FIFO 150, instead of once per packet and a successful read ahead may occur. The driver 452 may be enabled to pass a pointer to SKB 300 per call, for example, and an element of the virtual address database (VAD) 485 to the OS stack 354.

In accordance with an embodiment of the invention, the CPU stalls in OS stack 454 and system call 456 may be minimized as NIC 128 may know in advance which memory regions may need to be prefetched from host memory 126. The NIC 128 may be enabled to add addressing information to the data passed to the driver 452. The driver 452 may utilize the received addressing information to generate the VAD 485. The driver 452 may pass the VAD 485 to the OS stack 454 along with a linked list of buffers, for example, a plurality of SKBs, for example, for example, SKB 1 410, SKB 2 420, SKB 3 430, SKB 4 440 and SKB 5 450.

The CPU 102 may be enabled to receive the plurality of virtual addresses, for example, frag list 1 487, frag list 2 489, frag list 3 491, frag list 4 493, frag list 5 495 from NIC 128. The CPU 102 may be enabled to generate the virtual address database 485 based on the received plurality of virtual addresses, for example, frag list 1 487, frag list 2 489, frag list 3 491, frag list 4 493, frag list 5 495. The virtual address database 485 may be generated per CPU 102 for processing. The VAD 485 may comprise a plurality of pointers to the plurality of socket buffers, for example, SKB PTR 1 486, SKB PTR 2 488, SKB PTR 3 490, SKB PTR 4 492 and SKB PTR 5 494 and a plurality of virtual addresses, for example, frag list 1 487, frag list 2 489, frag list 3 491, frag list 4 493, frag list 5 495 corresponding to each of the plurality of data segments.

The CPU 102 may be enabled to prefetch a plurality of socket buffers, for example, SKB 1 410, SKB 2 420, SKB 3 430, SKB 4 440 and SKB 5 450 from host memory 126 utilizing VAD 485. The CPU 102 may enable caching of the prefetched plurality of socket buffers, for example, SKB 1 410, SKB 2 420, SKB 3 430, SKB 4 440 and SKB 5 450 in cache memory 160.

The OS stack 454 may be enabled to perform protocol processing and link the plurality of SKBs, for example, for example, SKB 1 410, SKB 2 420, SKB 3 430, SKB 4 440 and SKB 5 450 in order. The SKB1 410 may comprise a next1 field 412, a header1 field 414, a data1 field 416 and a frag list 1 418. The SKB2 420 may comprise a next2 field 422, a header2 field 424, a data2 field 426 and a frag list 2 428. The SKB3 430 may comprise a next3 field 432, a header3 field 434, a data3 field 436 and a frag list 3 438. The SKB4 440 may comprise a next4 field 442, a header4 field 444, a data4 field 446 and a frag list 4 448. The SKB5 450 may comprise a next5 field 452, a header5 field 454, a data5 field 456 and a frag list 5 458.

The linking and generation of the VAD 485 per CPU 102 may be performed before OS stack 454 processing. For example, the next field 412 in SKB1 410 may point to SKB2 420. The next field 422 in SKB2 420 may point to SKB3 430. The next field 432 in SKB3 430 may point to SKB4 440. The next field 442 in SKB4 440 may point to SKB5 450.

The OS stack 454 may be enabled to re-link the plurality of SKBs, for example, SKB 11 460, SKB 12 465 and SKB 13 470 in order. The SKB11 460 may comprise a next11 field 461, a header11 field 462, a data11 field 463 and a frag list 11 464. The SKB12 465 may comprise a next12 field 466, a header12 field 467, a data12 field 468 and a frag list 12 469. The SKB13 470 may comprise a next13 field 471, a header13 field 472, a data13 field 473 and a frag list 13 474.

The OS stack 454 may be enabled to generate VAD 475 per network flow for copying of the plurality of data segments to a plurality of user buffers. The VAD 475 may comprise a plurality of pointers to the plurality of socket buffers, for example, SKB PTR 11 476, SKB PTR 12 478 and SKB PTR 13 480 and a plurality of virtual addresses, for example, frag list 11 477, frag list 12 479 and frag list 13 481 corresponding to each of the plurality of data segments. The OS stack 454 may be enabled to pass the data buffers to a user receive system call 456 via a system call (syscall) function.

The system call 456 may enable copying of a plurality of data segments extracted from the cached plurality of socket buffers, for example, SKB 1 410, SKB 2 420, SKB 3 430, SKB 4 440 and SKB 5 450 to a plurality of user buffers. The plurality of data segments may be copied from the plurality of socket buffers, for example, SKB 11 460, SKB 12 470 and SKB 13 475 or utilizing the plurality of pointers to the plurality of socket buffers, for example, SKB PTR 11 476, SKB PTR 12 478 and SKB PTR 13 480.

The system call 456 may comprise kernel code running on behalf of a user process in its context, for example. The system call 456 may be enabled to extract data from the plurality of SKBs, for example, SKB11 460, SKB12 465 and SKB13 470. The prefetched plurality of socket buffers may be released after copying the plurality of data segments to the plurality of user buffers. The prefetching of the plurality of socket buffers, for example, SKB 1 410, SKB 2 420, SKB 3 430, SKB 4 440 and SKB 5 450 from host memory 126 may reduce a rate of cache misses in the OS stack 454 and the system call 456.

In accordance with an embodiment of the invention, a plurality of data segments may be prefetched using a virtual address database compared to prefetching only one data segment using a linked list. The number of read ahead prefetch commands needed to insure uninterrupted processing or no CPU stalls may differ from system to system. The prefetching of a significant number of data segments in an early stage or before it may be necessary may not improve performance as the data may not remain in cache memory 160 when required due to last recently used (LRU) behavior of the cache memory 160.

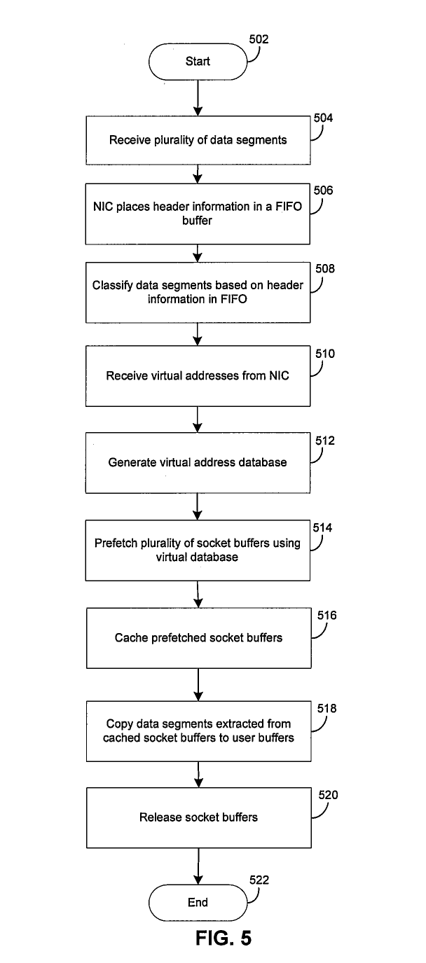

FIG. 5 is a flowchart illustrating exemplary steps for optimizing CPU performance for network ingress flow, in accordance with an embodiment of the invention. Referring to FIG. 5, exemplary steps may begin at step 502. In step 504, the NIC 128 may receive a plurality of data segments. In step 506, the NIC 128 may place header information corresponding to the received plurality of data segments in a FIFO memory buffer 150. In step 508, the received plurality of data segments maybe classified based on the placed header information in the FIFO memory buffer 150.

In step 510, a plurality of virtual addresses, for example, frag list 1 487, frag list 2 489, frag list 3 491, frag list 4 493, frag list 5 495 may be received from the NIC 128. In step 512, a virtual address database 485 may be generated based on the received plurality of virtual addresses. In step 514, a plurality of socket buffers, for example, SKB 1 410, SKB 2 420, SKB 3 430, SKB 4 440 and SKB 5 450 may be prefetched from host memory 126 utilizing the virtual address database 485. In step 516, the prefetched plurality of socket buffers may be cached in cache memory 160. In step 518, a plurality of data segments extracted from the cached plurality of socket buffers, for example, SKB 1 410, SKB 2 420, SKB 3 430, SKB 4 440 and SKB 5 450 may be copied to a plurality of user buffers. In step 520, the prefetched plurality of socket buffers may be released after copying the plurality of data segments to the plurality of user buffers. Control then passes to step 522.

In accordance with an embodiment of the invention, a method and system for optimizing CPU performance for network ingress flow may comprise a CPU 102 that enables prefetching a plurality of socket buffers, for example, SKB 1 410, SKB 2 420, SKB 3 430, SKB 4 440 and SKB 5 450 from host memory 126 utilizing a virtual address database 485. The CPU 102 may enable caching of the prefetched plurality of socket buffers in cache memory 160. The system call 456 may enable copying of a plurality of data segments extracted from the cached plurality of socket buffers, for example, SKB 1 410, SKB 2 420, SKB 3 430, SKB 4 440 and SKB 5 450 to a plurality of user buffers. The NIC 128 may be enabled to receive the plurality of data segments. The NIC 128 may be enabled to place header information corresponding to the received plurality of data segments in a first-in first out (FIFO) memory buffer 150. The driver 452 may be enabled to classify the received plurality of data segments based on the placed header information in the FIFO memory buffer 150. The FIFO memory buffer 150 may comprise contiguous memory regions to store the placed header information.

The virtual address database 485 may comprise a plurality of pointers to the plurality of socket buffers, for example, SKB PTR 1 486, SKB PTR 2 488, SKB PTR 3 490, SKB PTR 4 492 and SKB PTR 5 494 and a plurality of virtual addresses, for example, frag list 1 487, frag list 2 489, frag list 3 491, frag list 4 493, frag list 5 495 corresponding to each of the plurality of data segments. The plurality of data segments may be copied from the plurality of socket buffers, for example, SKB 11 460, SKB 12 470 and SKB 13 475 or utilizing the plurality of pointers to the plurality of socket buffers, for example, SKB PTR 11 476, SKB PTR 12 478 and SKB PTR 13 480.

The CPU 102 may be enabled to receive the plurality of virtual addresses, for example, frag list 1 487, frag list 2 489, frag list 3 491, frag list 4 493, frag list 5 495 from NIC 128. The CPU 102 may be enabled to generate the virtual address database 485 based on the received plurality of virtual addresses, for example, frag list 1 487, frag list 2 489, frag list 3 491, frag list 4 493, frag list 5 495. The virtual address database 485 may be generated per CPU 102 for processing. The virtual address database 475 may be generated per network flow for copying of the plurality of data segments to a plurality of user buffers. The prefetched plurality of socket buffers may be released after copying the plurality of data segments to the plurality of user buffers. The prefetching of the plurality of socket buffers, for example, SKB 1 410, SKB 2 420, SKB 3 430, SKB 4 440 and SKB 5 450 from host memory 126 may reduce a rate of cache misses in the OS stack 454 and the system call 456.

Another embodiment of the invention may provide a machine-readable storage, having stored thereon, a computer program having at least one code section executable by a machine, thereby causing the machine to perform the steps as described herein for optimizing CPU performance for network ingress flow.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing data, the method comprising:
prefetching a plurality of socket buffers from host memory utilizing a virtual address database;
caching said prefetched plurality of socket buffers; and
copying a plurality of data segments extracted from said cached plurality of socket buffers to a plurality of user buffers.

2. The method according to claim 1, comprising receiving said plurality of data segments from a network interface controller (NIC).

3. The method according to claim 2, wherein said NIC places header information corresponding to said received plurality of data segments in a first-in first out (FIFO) memory buffer.

4. The method according to claim 3, comprising classifying said received plurality of data segments based on said placed header information in said FIFO memory buffer.

5. The method according to claim 2, wherein said virtual address database comprises a plurality of pointers to said plurality of socket buffers and a plurality of virtual addresses corresponding to each of said plurality of data segments.

6. The method according to claim 5, comprising copying said plurality of data segments utilizing said plurality of pointers.

7. The method according to claim 5, comprising receiving said plurality of virtual addresses from said NIC.

8. The method according to claim 7, comprising generating said virtual address database based on said received plurality of virtual addresses.

9. The method according to claim 1, comprising generating said virtual address data base per central processing unit (CPU) for processing.

10. The method according to claim 1, comprising generating said virtual address data base per network flow for said copying.

11. The method according to claim 1, comprising releasing said prefetched plurality of socket buffers after said copying.

12. The method according to claim 1, wherein said prefetching reduces a rate of cache misses.

13. A system for processing data, the system comprising:
one or more circuits that enables prefetching of a plurality of socket buffers from host memory utilizing a virtual address database;
said one or more circuits enables caching of said prefetched plurality of socket buffers; and
said one or more circuits enables copying of a plurality of data segments extracted from said cached plurality of socket buffers to a plurality of user buffers.

14. The system according to claim 13, wherein said one or more circuits enables receipt of said plurality of data segments from a network interface controller (NIC).

15. The system according to claim 14, wherein said NIC places header information corresponding to said received plurality of data segments in a first-in first out (FIFO) memory buffer.

16. The system according to claim 15, wherein said one or more circuits enables classification of said received plurality of data segments based on said placed header information in said FIFO memory buffer.

17. The system according to claim 14, wherein said virtual address database comprises a plurality of pointers to said plurality of socket buffers and a plurality of virtual addresses corresponding to each of said plurality of data segments.

18. The system according to claim 17, wherein said one or more circuits enables copying of said plurality of data segments utilizing said plurality of pointers.

19. The system according to claim 17, wherein said one or more circuits enables receipt of said plurality of virtual addresses from said NIC.

20. The system according to claim 19, wherein said one or more circuits enables generation of said virtual address database based on said received plurality of virtual addresses.

21. The system according to claim 13, wherein said one or more circuits enables generation of said virtual address data base per central processing unit (CPU) for processing.

22. The system according to claim 13, wherein said one or more circuits enables generation of said virtual address data base per network flow for said copying.

23. The system according to claim 13, wherein said one or more circuits enables release of said prefetched plurality of socket buffers after said copying.

24. The system according to claim 13, wherein said prefetching reduces a rate of cache misses.
